(19) United States
(12) Patent Application Publication
(10) Pub. No.: US 2013/0046573 A1
(43) Pub. Date: Feb. 21, 2013

(54) Computer-Implemented Systems and Methods for Financial Close Management

(71) Applicants: Miguel A. Zubizarreta, Westlake, OH (US); Gabriel Modesto Zubizarreta, Santa Clara, CA (US)

(72) Inventors: Miguel A. Zubizarreta, Westlake, OH (US); Gabriel Modesto Zubizarreta, Santa Clara, CA (US)

(21) Appl. No.: 13/589,212

(22) Filed: Aug. 20, 2012

Related U.S. Application Data
(60) Provisional application No. 61/525,507, filed on Aug. 19, 2011.

(51) Int. Cl. G06Q 10/06; G06Q 40/00

(52) U.S. Cl. 705/7.15; 705/30

(57) ABSTRACT

Systems and methods are provided for the management and automation of a financial reporting process. A system includes a database that includes data for tracking each of a plurality steps required to perform a financial close for an organization, where steps are either general account tasks required to be completed for the financial close, accounting tasks that constitute accounting controls, or accounting tasks that represent a creation of a journal entry. A graphical user interface provides each user with visibility of steps they are required to perform as part of the financial close and allows that user to record when they have completed a task. The graphical user interface further provides a status of other steps that may be relevant to that user's ability to perform their tasks. A computer program provides monitoring data for financial department management to monitor progress of each of the steps.

### CROSS-REFERENCE TO RELATED APPLICATION

This application claims priority to and the benefit of U.S. Provisional Application Ser. No. 61/525,507, filed on Aug. 19, 2011, entitled “Computer-Implemented Systems and Methods for Financial Close Management,” of which the entire disclosure (including any and all figures) is incorporated herein by reference.

### TECHNICAL FIELD

This document relates generally to computer-implemented accounting and more particularly to computer-implemented financial close management.

### BACKGROUND

Corporate accounting has been significantly computerized over the last four decades. Concepts like the general ledger have grown from paper to spreadsheets to accounting systems that help manage entire corporations. Likewise, many transactional accounting areas such as payables and receivables have been significantly computerized and automated. Many corporations have periodic auditing and reporting requirements that may be complex and time consuming to complete.

### SUMMARY

In accordance with the teachings herein, systems and methods are provided for the management and automation of a financial reporting process. A system includes a database that includes data for tracking each of a plurality steps required to perform a financial close for an organization, where steps are either general account tasks required to be completed for the financial close, accounting tasks that constitute accounting controls, or accounting tasks that represent a creation of a journal entry. A graphical user interface provides each user with visibility of steps they are required to perform as part of the financial close and allows that user to record when they have completed a task. The graphical user interface further provides a status of other steps that may be relevant to that user's ability to perform their tasks. A computer program provides monitoring data for financial department management to monitor progress of each of the steps.

### BRIEF DESCRIPTION OF THE FIGURES

FIG. 1 is a block diagram depicting a computer-implemented financial close management engine.

FIG. 2 is a block diagram depicting accounting data that may be generated and modified using a financial close management engine.

FIG. 3 is a block diagram depicting the transmission of accounting data and task data to different types of users via graphical user interfaces.

FIG. 4 is a block diagram identifying example task data that may be tracked by a financial close management engine.

FIG. 5 depicts example data structures that may be utilized by a financial close management engine.

FIG. 6 is a flow diagram depicting example operations that may be performed in executing a task.

FIG. 7 is a flow diagram depicting interactions of a management user with a financial close management engine.

FIG. 8 is a flow diagram depicting interactions of a task definer with a financial close management engine.

FIG. 9 depicts an example relationship between task templates and task records in a set of task data.

FIG. 10 is a flow diagram depicting completion of audit tasks.

FIG. 11 depicts an example company hierarchy.

FIGS. 12A, 12B, and 12C depict example systems for use in implementing a financial close management engine.

FIGS. 13-19 depict example user interfaces for implementing a financial close management engine.

FIGS. 20A, 20B, 20C, 20D, and 20E depict an example task data schema.

### DETAILED DESCRIPTION

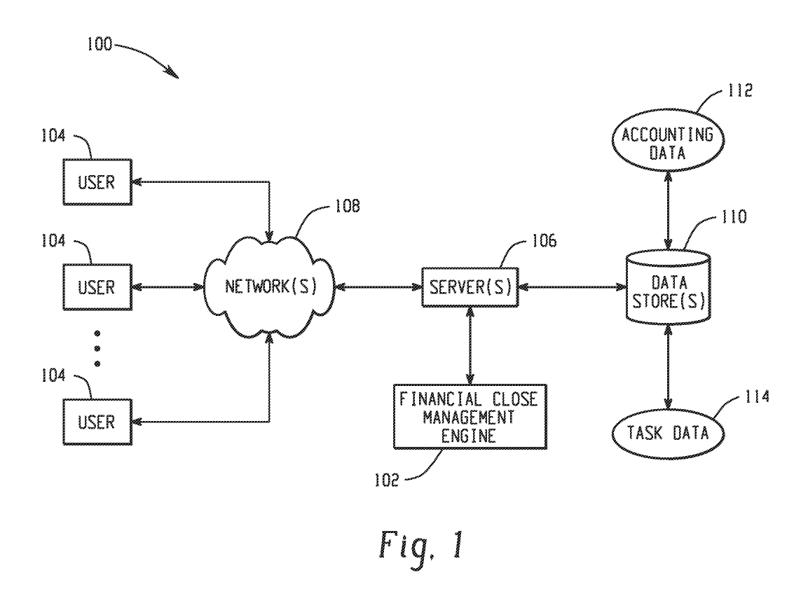

FIG. 1 is a block diagram depicting a computer-implemented financial close management engine. FIG. 1 depicts a computer-implemented financial close management engine 102 for facilitating the management and automation of the financial reporting process. The need for timely financial reporting has increased as the financial world expects faster and more accurate financial statements in an increasing complex regulatory environment. Sarbanes-Oxley Act (SOX), Japanese SOX laws (jSOX), and other legislative and regulatory requirements drive the need to improve and optimize the financial reporting process. This process is very labor intensive and time constrained. The financial reporting process is an area that has seen very little improvement and today is still managed with the most rudimentary tools from the 1980's, mostly using spreadsheets.

Most companies have a complex process for the creation of their financial reporting. Oftentimes, the financial closing process completely consumes the finance department for a significant period of time (e.g., at the beginning of each month) as the department prepares the financials. For most companies, the beginning of each month is a period of high stress, with daily significant late working hours until the month is closed. This monthly grind has a significant impact on the morale and attitude of financial department employees.

Additionally, the unavailability of any finance department resource during this time period causes significant disruption to the process. Each person may be assigned many tasks that interlock with tasks performed by other workers, and the loss of any specific worker may cause a significant ripple effect throughout the group. Most finance departments lack sufficient cross training to compensate for a missing employee, and a fill-in-worker who does not perform the tasks regularly may be more prone to commit errors or fail to notice unusual circumstances or amounts that might signify upstream errors flowing into the assigned tasks. Many accounting departments forbid any vacation or absences during this “closing period” of time, from the last days of the month to the beginning of the month until the financials are closed.

There is also a significant corporate risk associated with the significant negative impacts of an incorrect financial statement. Material errors in a financial statement are the cause of a company restating their financial statement. Most companies that restate their financial statements suffer significant financial consequences. Often, the valuation of a company's shares suffers because the market loses confidence that their financials, from which the valuation of the company is derived, can be trusted now or into the future. Often this effect can last years. Restated financials expose the company to shareholder class action lawsuits. Along with the company's reputation being damaged, a company's bond rating, which determines their borrowing interest rate, may be negatively impacted, which in turn causes the company's interest rates to be increased. A restatement could cause a company's bankers to reduce their lending or re-price their loans. Additionally, the reputation of the auditors that signed off on the original financial statement may be impacted by the restatement. Auditors are likely to subject the company to significant additional scrutiny at additional audit costs. All of these results may impact the company for several years.

The financial close management engine 102 provides a mechanism for ensuring a consistently accurate report the financial condition of the company. Companies may have between several hundreds to thousands of steps required to be prepared, reviewed, approved, and completed each month. The steps and their sequence may be unique to each company. In addition, the steps are not static. Each period (e.g., month, quarter), some of the steps may be improved or refined.

The increased communication and visibility provided by a financial close management engine can provide numerous benefits. Users are promptly notified when upstream tasks are completed so that they may begin their assigned tasks when they are available without a requirement of active communication to the upstream task users. Express definition of procedures in a centralized location provides assurance that tasks are being completed correctly and that changes in task procedures are quickly and accurately communicated to assigned users. Increased visibility of the process also aids in the identification of errors. Because the interdependency among tasks is clearly visible, the effects of an error in one task can be followed downstream to fix the effects of error and upstream to find the source of the error.

FIG. 1 discloses a financial close management engine 102 that facilitates the providing of tasks to be completed to assigned users, tracking of task completion, definitions of tasks and task procedures, and other facets of the financial closing process to enable a company to streamline the financial closing process and ensure compliance with company financial procedures. A user 104 accesses the financial close management engine 102 via one or more servers 106 through one or more networks 108. The one or more servers 106 are responsive to one or more data stores 110. The one or more data stores 110 may contain a variety of data that includes accounting data 112 and task data 114.

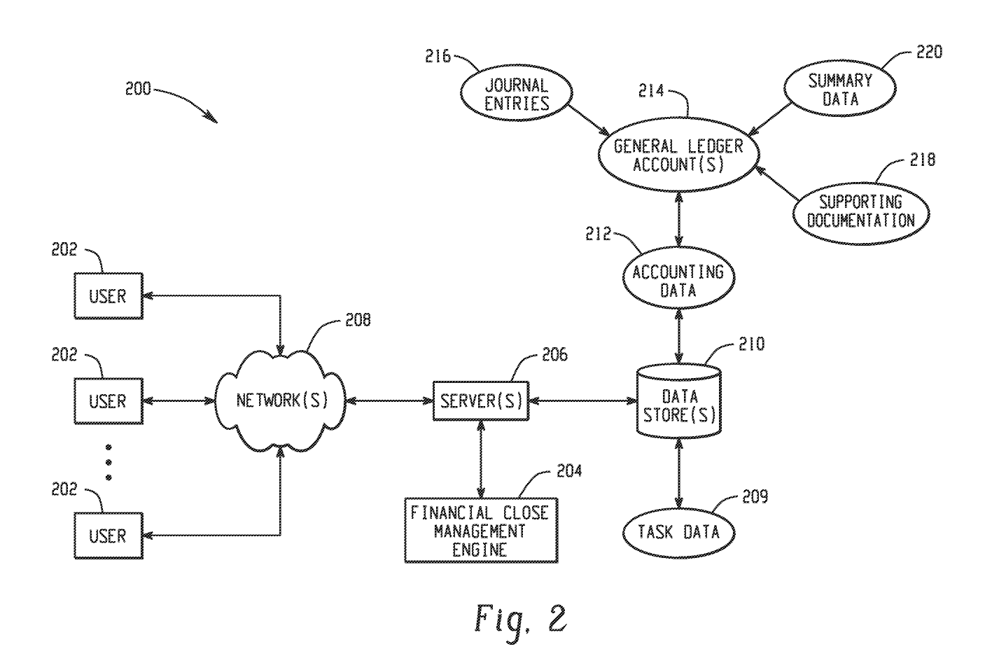

FIG. 2 is a block diagram depicting accounting data that may be generated and modified using a financial close management engine. One or more users 202 access the financial close management engine 204 via one or more servers 206 through one or more networks 208. A user 202 may access the financial close management engine 204 to complete one of a variety of different tasks, as identified by task data 209 stored in one or more data stores 210. Tasks may include data entry tasks, data review tasks, data approval tasks, management tasks, auditing task, procedure testing tasks, as well as others.

Many of the tasks provided to a user 202 require creation of, entry of, or modifications to accounting data 212. The accounting data 212 may include data related to one or more general ledger accounts 214 for which the financial close management engine 204 is managing a financial close. A number of journal entries 216 may be associated with a general ledger account 214 that contain data related to transactions of a company. An example task assigned to a user 202 may be to review journal entries 216 for a particular company area (e.g., manufacturing, research and development) and to verify the accuracy of those journal entries 216. The user 202 may be required to generate supporting documentation 218, such as a spreadsheet, to validate that the assigned task was completed correctly. The generated supporting documentation 218 may be stored as accounting data 212 for later review, such as by a reviewing supervisor. Documentation for prior financial close periods may be provided to the user to give the user a starting point when working on a task. When the user 202 completes the verification task, the completion is noted in the task data, and downstream tasks of the verification task may be enabled. For example, summary data 220 may be generated once all tasks on which the summary data generation task depends are completed (e.g., summary data of a total of electricity costs across multiple plants may be generated once electricity cost data at all of the plants has been verified).

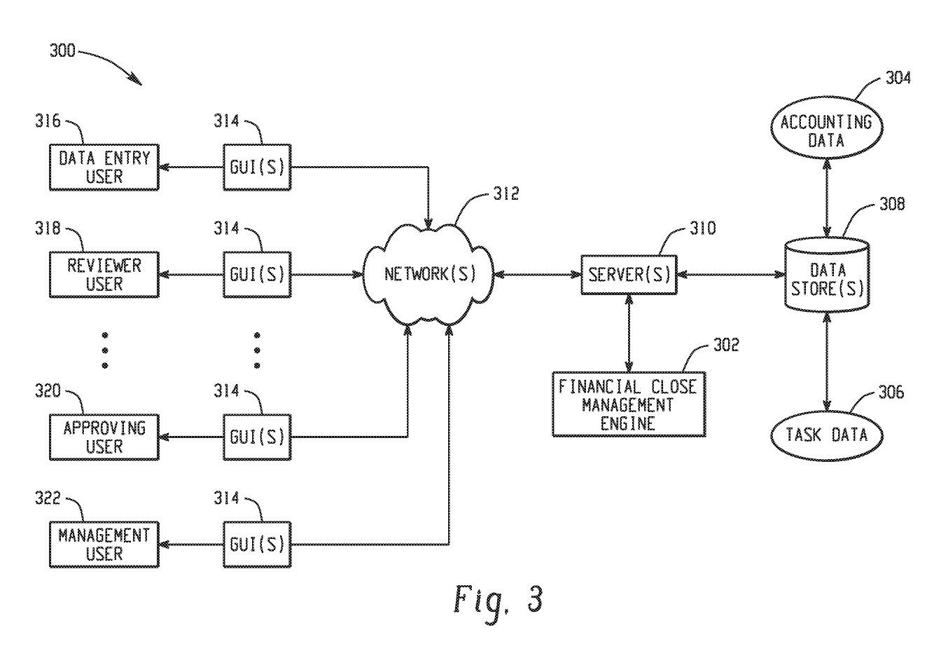

FIG. 3 is a block diagram depicting the transmission of accounting data and task data to different types of users via graphical user interfaces. The financial close management engine 302 transmits the accounting data 304 and task data 306 that is stored on the one or more data stores 308 using the one or more servers 310 through the one or more networks 312. The financial close management engine 302 provides the data 304, 306 to the users for display on graphical user interfaces 314 according to user identities. For example, different account data 304 and task data 306 may be provided to a data entry user 316 than is provided to a reviewer user 318 than is provided to an approving user 320 or a management user 322.

The differentiation of data provided to the users 316, 318, 320, 322 may be based on task assignment. A data entry user 316 may be required to enter certain accounting data 304 based on journal entries for a general ledger account for a data entry task. Thus, the data entry user 316 may be provided low level data via a graphical user interface 314 for completing that task. A reviewer user 318 may be provided similar low level data along with the accounting data entered by the data entry user 316 to review that the data was entered properly for a review task. The accounting data entered by the data entry user 316 along with details of the verification by the reviewer user 318 may be provided to an approving user 320 who approves the entered data for an approval task. A management user 322 may be provided higher level data, such as summary data totaling data entered by multiple data entry users 316 (e.g., fuel costs across multiple factories) for a management task.

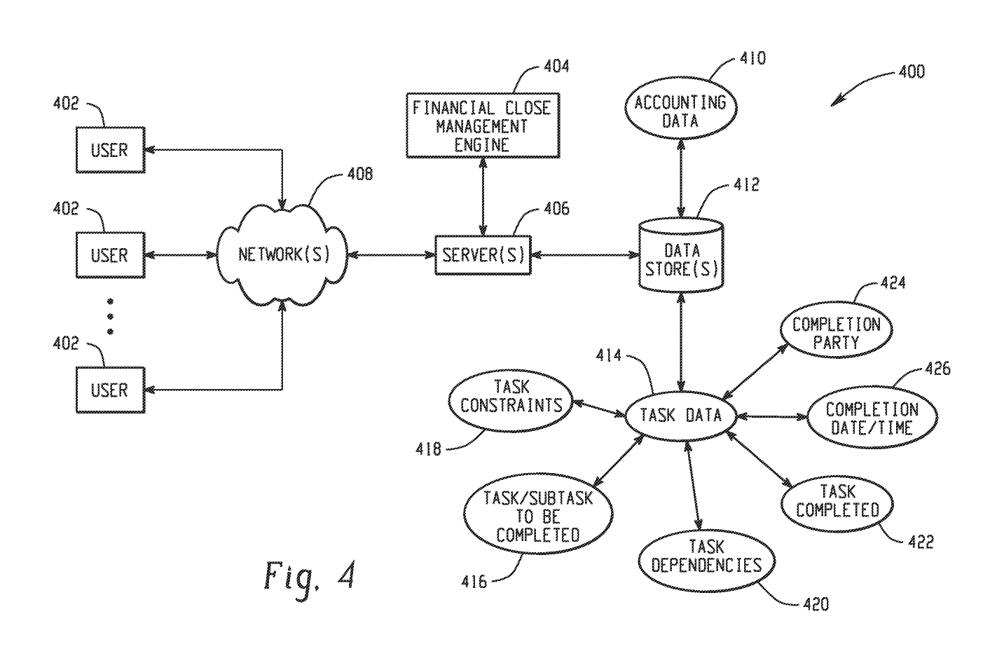

FIG. 4 is a block diagram identifying example task data that may be tracked by a financial close management engine. Users 402 access the financial close management engine 404 via a server 406 through one or more networks 408. The users 402 are provided graphical user interfaces to facilitate performance of financial closing tasks. For example, a user may be provided a list of tasks that need to be completed. The list may include notations as to whether the tasks are available for completion. A task may be unavailable for a variety of reasons, such as a lack of completion of an upstream task on which the task depends. The user 402 may select a task to complete and be provided information about the selected task along with procedures for completing the task. For example, the user may be provided a graphical user interface that receives input accounting data 410 for storage in one or more data stores 412. The graphical user interface may include instructions or a link to instructions that describe the procedures that should be performed in completing the task. The fields provided to the user 402 and the procedures may be modified by a task definer, as described in further detail herein.

The financial close management engine 404 may direct the capture and storage of a variety of task data 414 related to the performance of a selected task. For example, the task data 414 may include task description data 416 about the task or sub-task to be completed. The task data 416 may include the name of the task, a description of the task, and procedures that are to be performed in correctly performing the task. The task data 414 may also include one or more task constraints 418. Task constraints 418 identify certain limitations on the performance of tasks, such as which users are permitted to perform the tasks, a timeframe in which a task must be performed, or other limitations. For example, a task constraint 418 for a task that requires data entry, data review, and data approval may dictate that the data entry user must be a different user than the data review user, where both the data entry user and the data review user must be a different user than the data approval user.

The task data 414 may also include data related to task dependencies 420. A particular task may rely on data from previous tasks to be properly performed. Similarly, a particular task may need to be performed before a subsequent task may be properly executed. Task dependency data 420 may identify predecessor and successor tasks of a particular task. Using the dependency data 420 the particular task may be made available for completion when all predecessor tasks are noted as complete. Similarly, a successor task may be made available for completion when the particular task and all other predecessors of the successor task are completed. A particular task (or sub-task) may also include a number of sub-tasks to be performed as part of performance of the particular task. In this way, a one-to-many relationship may exist between a particular task and sub-tasks of the particular task.

The task data 414 may also track a number of metrics regarding completion of the task. The task data 414 may include a task completed flag 422 that is set when a particular task is completed. The task data may also include completion party data 424 that identifies the user 402 who completed a task as well as completion date/time data 426 that notes when the task was completed. Certain tasks may require completion by multiple parties. For example, a particular task may require completion of data entry, data review, and data approval. The status of each of these sub-tasks may be noted in a task record. Alternatively, the separate sub-tasks may be tracked as separate tasks using individual task records.

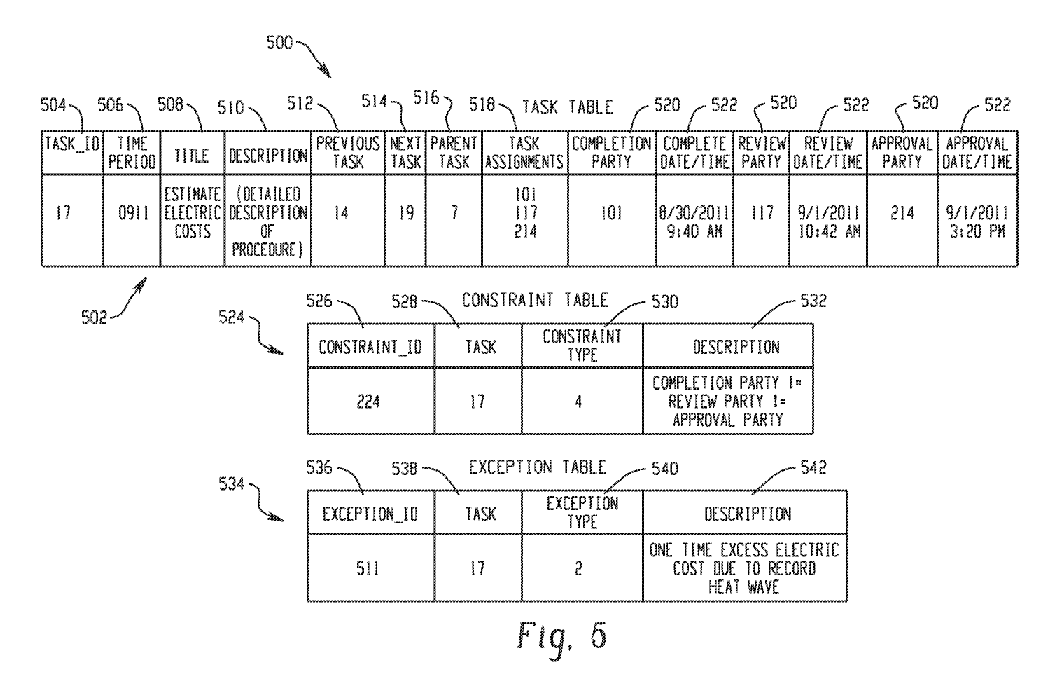

FIG. 5 depicts example data structures that may be utilized by a financial close management engine. The example data structures include a task table 502 that includes a task data record. A task data record may include a number of fields. For example, the task data record 502 may include a task_id 504 index that may be used to access the task data record or for other data records to reference the task data record. The task data record 502 also includes a time period field 506. The time period field 506 identifies that time period with which the task record is associated (e.g., September, 2011). Certain tasks may be repeated every month or other time period, where a replication of the task is generated each month including the time period identifier, such as by using task templates as described further herein. The task data record 502 may also include description fields including a title field 508 and a description field 510. The description field 510 may include a listing of detailed procedures that are to be performed in completing the task that can be displayed to a user working on the task. The task record 502 may also include task dependency data, such as fields identifying a previous task 512, a next task 514, and a parent task 516 when the task record is identifying a subtask (e.g., task 17 related to electric cost estimating may be a sub-task of a larger plant costs estimating task).

The task record 502 may also include data fields related to the assignment and completion of the task. For example, a task assignment field 518 identifies the users that are assigned to complete the task, review completion of the task, and approve completion of the task (i.e., employees number 101, 117, and 214, respectively). The task data record 502 also includes identifications of the parties that actually completed the portions of the tasks at 520 as well as the dates and times those task portions were completed at 522.

Many other types of data structures may be used for tracking task completion and financial close procedure compliance. For example, a constraint data record 524 identifies constraints that are to be imposed on the completion of a given task. The constraint data record includes a constraint index 526 and a task identifier 528 that identifies the task at 502 to which the constraint data record 524 refers. A constraint type is identified at 530 along with a description of the constraint at 532. The particular depicted constraint 524 is a constraint on the identity of parties working on the particular task described at 502. Specifically, the depicted constraint 524 requires that the completion party cannot be the same as the review party, and neither the completion nor the review party can be the same as the approval party.

An exception data record 534 identifies other data that may be tracked in performing a financial close. The exception data record 534 includes an index 536 as well as a task identifier 538 that identifies the task at 502 to which the exception data record 534 refers. The exception data record 534 includes an identification of the type of exception that a user wishes to note along with a description 542 of the identified exception 534. A financial close management engine 504 may provide boundary estimates within which an entered value is expected to be. When an entered value exceeds the boundary estimates, a user may be required to enter an exception note to explain the deviation from the boundary estimates. An exception note may also be required when a task is not completed on time or at all. The exception note identified by the exception data record 534 may be required for compliance reasons and may be useful in identifying potential errors should errors be detected in a financial closing process.

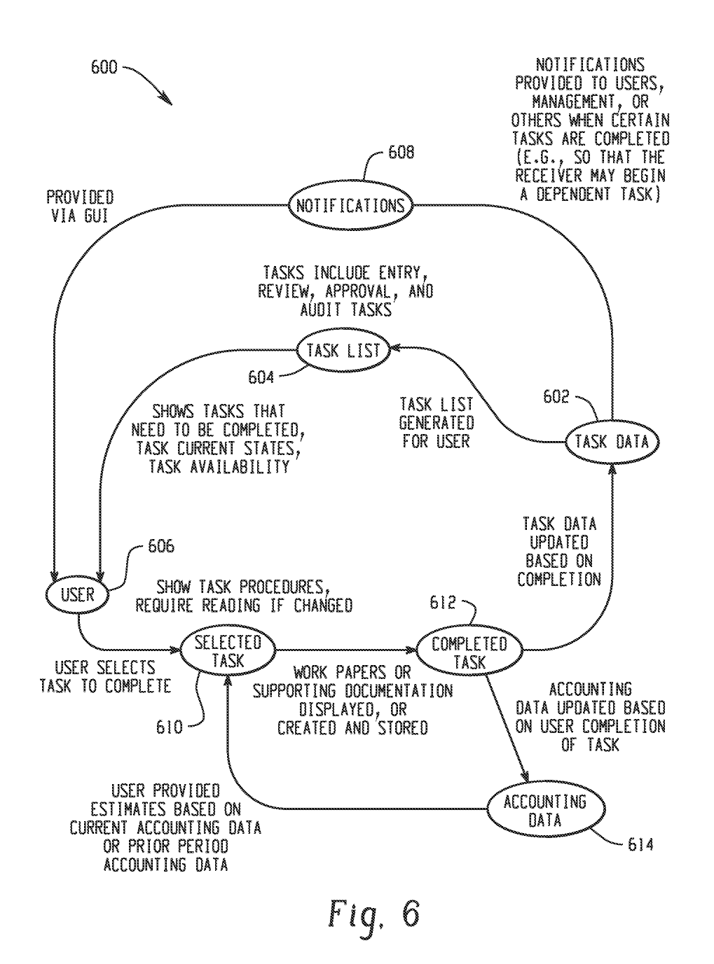

FIG. 6 is a flow diagram depicting example operations that may be performed in executing a task. Task data 602 may be accessed to generate a task list 604 for a user 606. The task list 604 may identify tasks that need to be performed by the user 606 during the current closing period. The task list 604 may also include a listing of tasks that need to be performed by subordinates of the user 606. The tasks appearing on a task list graphical user interface for the user 606 may belong to a number of different categories including data entry and calculation tasks, data review tasks, data approval tasks, and auditing tasks. The task list may further include a status indicator with each task on the task list 604. The status indicator may identify the task as completed or not completed. The status indicator may further identify whether a listed task is available for work. A task is available for work when the financial close management engine is able to access all accounting data on which the task relies. When upstream tasks on which a listed task depends have not been completed, then the listed task is unavailable. When the upstream tasks have been completed, the status indicator for the listed task may be changed to available.

The information provided by the task list 604 may be bolstered by configurable notifications 508 that may be sent when certain task conditions are met. For example, an e-mail, voice mail, or text message notification 508 may be sent to designated users when a certain task has been permitted. Upon completion of the certain task, assignees of downstream tasks that depend on the certain task may receive a notification 508 informing the assignee that the predecessor task has been completed and that the assignee may begin work on their task.

At 610, the user 606 selects a selected task from the task list 604. For example, a user 606 tasked with reviewing a data entry task may select the review task at 610 after the data entry task has been completed. A graphical user interface may be provided to the user 606 to aid in completion of the task. The graphical user interface may include procedure data identifying all of the steps that are to be performed by the user 606 in properly executing the selected task 610. Such procedure data may be explicitly listed or available via a link. If the procedure data has changed, such as since the last financial closing period, the user 606 may be required to read the procedures. The graphical user interface may also include value estimates to help a user determine whether the accounting data they plan to enter is reasonable. The value estimates may be based on prior period data, current period data entered via other tasks, value estimates explicitly programmed into a task template, or other data.

The user 606 completes the task at 612, a process that may include generation or updating or supporting documentation, such as spreadsheets, which is stored for later access by the user 606 or others. The accounting data 614 is updated to reflect the data entered by the user 606 in completing the task. The task data 602 is also updated based on the completion of the task. The task data may be updated to reflect the identity of the user 606 that completed the task, the date/time of the task completion, whether the task was completed successfully or not, as well as other data.

Notifications 608 may be sent based on the completion of the selected task 604 and task lists for the user 606 or other users may be updated to reflect the completion of the task. For example, where the selected task 610 is a data entry review task, upon completion of the review task, a data entry approval user may have their task list 604 updated to reflect the approval task as available based on the completion of the upstream review task on which the approval task depends.

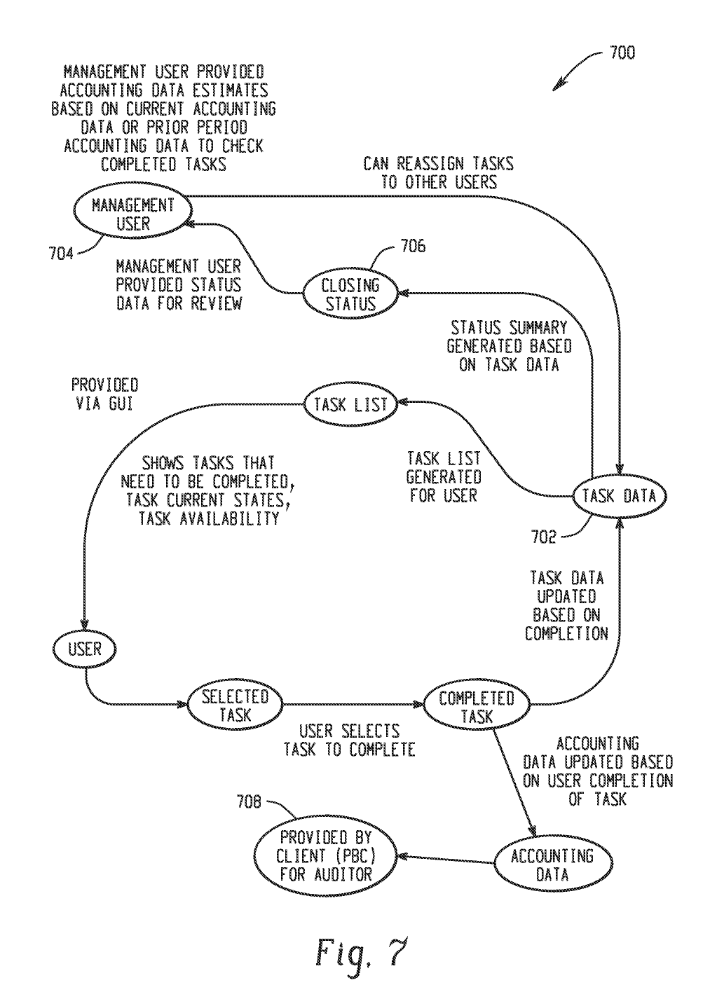

FIG. 7 is a flow diagram depicting interactions of a management user with a financial close management engine. Based on the current state of task data 702 a management user 704 may be provided a financial closing status report 706. The closing status report 506 may include a variety of data including summary statistics based on aggregations of journal entries or other company metrics. The management user 704 is provided the closing status report 706 for review. The management user 704 may also be provided with estimate values to aid in judgment as to whether the closing status report 706 is reasonable. For example, the closing status report 706 may include value estimates based on data from the current closing period or estimates for the depicted metrics from prior financial closing periods. The management user 704 may perform a number of management tasks based on the graphical user interfaces provided. For example, the management user may use the graphical user interfaces to reassign tasks to different users (e.g., a substitute user may be assigned a task when the primary user for the task is ill or on vacation). The task data 702 is updated to reflect the management commands entered by the management user 704 via the provided graphical user interfaces. A management user 704 may also generate a number of different outputs for the management user 704 or others to review. For example, the management user 704 may generate a provided by client (PBC) report 708 that is provided to an auditor for review of the financial close process.

Additional reports may also be available to the management user 704 to communicate the progress of the current financial close process. For example, a metric may be provided to identify whether the current financial close process is ahead of or behind schedule. A metric may be provided to identify whether the current financial close process as a whole or any individual tasks are ahead of a previous month's progress or an average progress (e.g., task 7 is incomplete but was complete at this point last financial close at this time, End of Month+1). Through such reporting, bottlenecks may be identified and addressed through personnel management or process evolution.

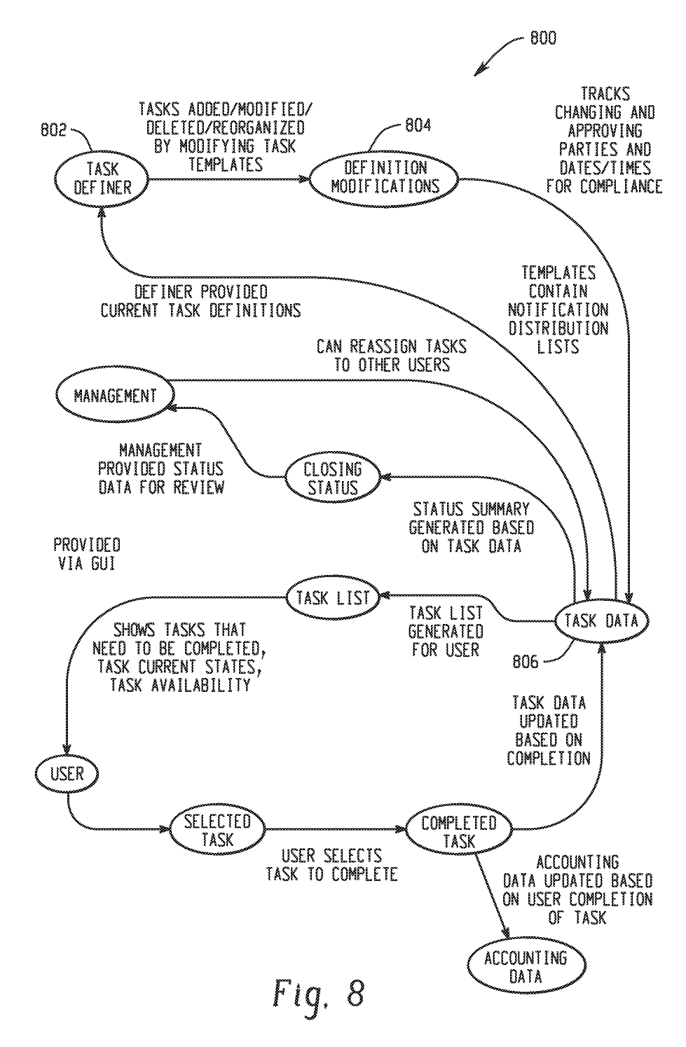

FIG. 8 is a flow diagram depicting interactions of a task definer with a financial close management engine. A task definer 802 adds, modifies, deletes or reorganizes tasks, as shown at 804. For example, a task definer 802 may initially design and enter each of a large number of tasks when setting up a financial close management engine 804 for a company. The task design may include identifying task procedures, accounting data fields associated with a task, required supporting documents for a task, and dependencies among tasks. The designed tasks may create a framework of tasks that are to be performed during each financial close period. A task designer may also incorporate ad hoc tasks, which are one time tasks that are implemented to address a special scenario that does not often occur.

Task definitions may be implemented using task templates. Task templates identify the parameters for a task and are useful in scenarios where certain tasks are to be performed regularly, such as during each reporting period. For example, at the beginning of a closing period, a task data record may be implemented in the task data 806 for each active task template. The task data record identifies the closing period with which it is associated, and performance of that task is monitored by the financial close management engine. A task template may identify the default user to be assigned a task, the associated task procedures, dependencies associated with the task to be generated using the template, procedures for supplying value estimates on a task completion graphical user interface, distribution lists identifying parties who should be notified upon completion of the task, as well as other data.

Once all tasks are defined for a company, the tasks may be periodically reviewed and modified to improve performance or as required by compliance regulations. Modifications to tasks or task templates may be tracked to meet compliance requirements. For example, a task change may need to be reviewed and approved by different parties before being implemented as task templates for use in succeeding closing periods. The task data 806 may record such review and approval data (e.g., reviewing parties, approval dates/times) so that a sufficient audit trail is maintained for all task changes.

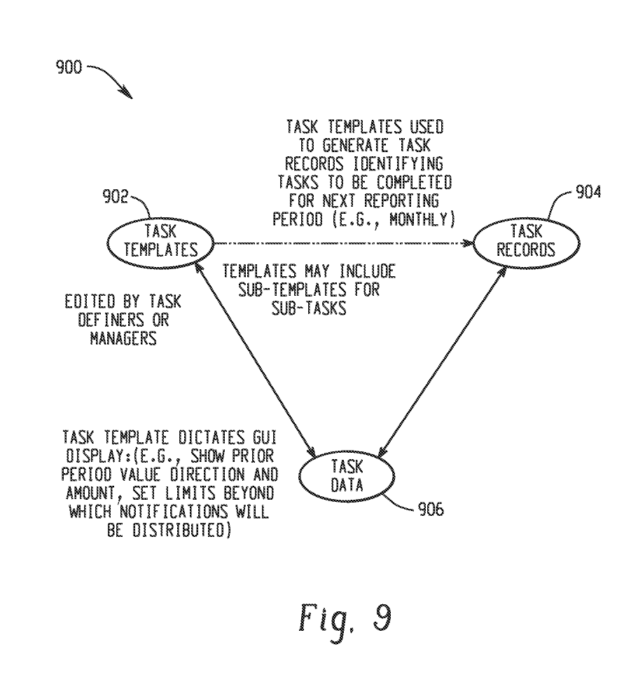

FIG. 9 depicts an example relationship between task templates and task records in a set of task data. A task template 902 is created and edited by task definers or managers and represents a task that will be implemented more than once (e.g., monthly, quarterly, yearly). When a new closing period is ready for task generation, task records 904 are generated according to associated task templates. Task templates may include details of a task and/or sub-tasks that are to be present in the generated task record 904. For example, the task template 902 may dictate items to be displayed on a graphical user interface for a user working on the task associated with task template 902 such as value estimates based on prior or current closing period data. In one example, the task template includes an acceptable range for a value to be entered by a user as part of a task execution. The acceptable range may be absolutely defined in the task template 902, may be relative to a prior closing period's value (e.g., +/−N % of last month's value), or may be based on other data values entered for the current closing period. If a user enters a value outside of the acceptable range, the user may be required to fill out an exception form to explain the discrepancy, and/or notifications may be sent to certain parties identified in the task template to inform the certain parties of the deviation from the acceptable values. The task templates 902 may be stored with the task records 904 in a single task data data store 906 or may be stored separately over multiple data stores.

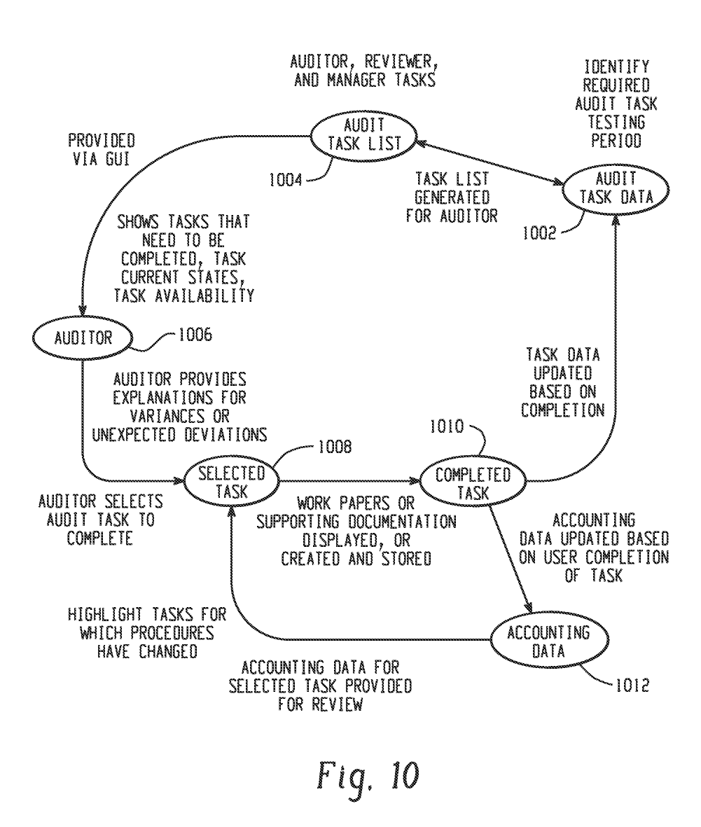

FIG. 10 is a flow diagram depicting completion of audit tasks. In addition to performing financial closing tasks, regulations and reporting requirements often demand periodic audits of the financial closing process. Task data may include audit task data 1002 that identifies audit tasks to be performed as part of a financial closing process. An audit task list 1004 is generated for an auditor. An audit task may require approval by a number of users, such as an auditor, a reviewer, and a manager as dictated by the audit task data 1002. The audit task list 1004 is provided to the auditor 1006 via a graphical user interface and lists tasks that need to be completed by the auditor 1006, the current states of the listed tasks, and the current availability of those tasks to be addressed by the auditor 1006.

The auditor 1006 selects a task to complete 1008 and is provided a graphical user interface to aid in completion of the selected task 1008. The graphical user interface may incorporate accounting data 1010 for the auditor to review. Special highlighting may be provided for tasks whose procedures have changed since a prior closing period. For example, if a data entry user's procedures for a particular task have changed, that particular task may be flagged for the auditor to carefully review the data entry user's work. Tasks having new procedures may be sources of errors that should be checked by the auditor with a higher degree of caution. An auditor may fill out forms to identify explanations for variances or unexpected deviations in the accounting data 1010. The auditor 1006 may be required to generate work papers or supporting documents or review such documents in cases of variances or deviations. Once the auditing task is completed at 1010, the accounting data 1012 is updated based on any additions or changes made by the auditor 1006. The task data 1002 is also updated to reflect the party that completed the task, the date/time of completion, and other details of the audit task completion 1010.

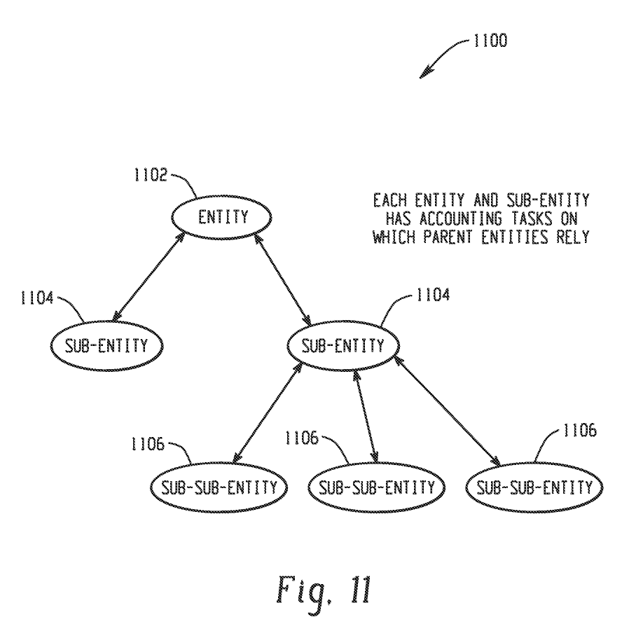

FIG. 11 depicts an example company hierarchy. A company may not only include an entity 1102 itself, but may also include a number of sub-entities 1104 and sub-sub-entities 1106. To perform a financial closing process for the entity 1102, individual financial closing processes may need to be performed for each of the sub-entities 1104 and sub-sub-entities 1106 because financial closing for each entity in the depicted hierarchy 1100 may depend on financial closings for entities at lower levels of the hierarchy. The financial close management engine tracks these dependencies so that financial closing processes for large organizations (e.g., a multi-national corporation having many subsidiaries, closely held organizations, and other related entities) can be performed in an orderly fashion with adequate tracking to ensure proper execution. For example, all sub-sub-entities' financial records must be closed before an associated sub-entity's financial records may be closed for a reporting period, and all sub-entity financial records must be closed before the entity's financial records may be closed for the reporting period.

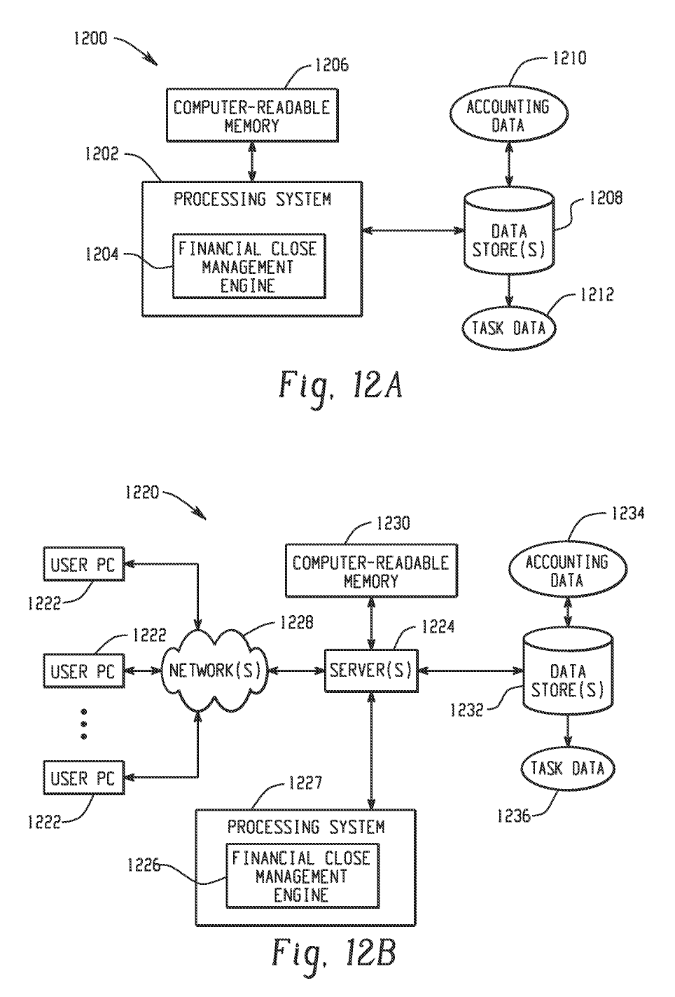

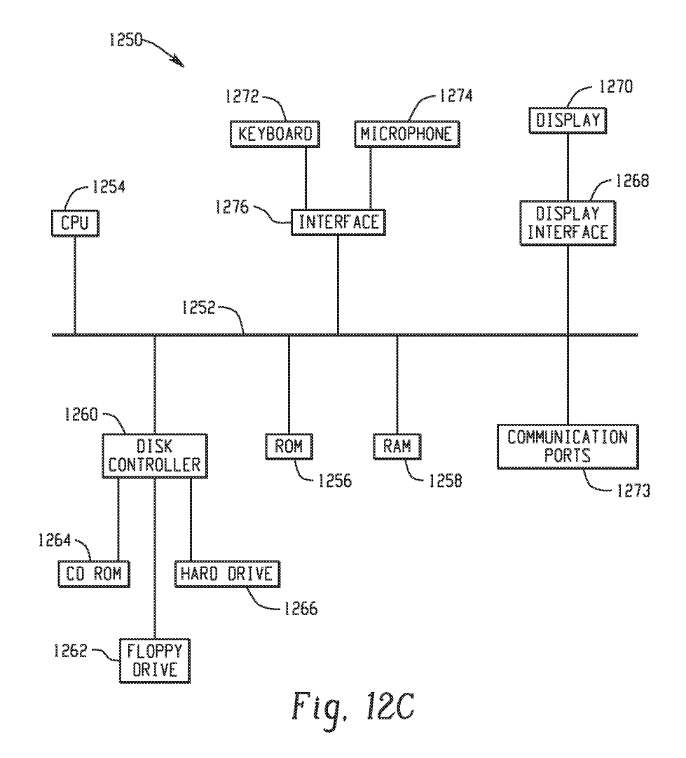

FIGS. 12A, 12B, and 12C depict example systems for use in implementing a financial close management engine. For example, FIG. 12A depicts an exemplary system 1200 that includes a standalone computer architecture where a processing system 1202 (e.g., one or more computer processors) includes a financial close management engine 1204 being executed on it. The processing system 1202 has access to a computer-readable memory 1206 in addition to one or more data stores 1208. The one or more data stores 1208 may include accounting data 1210 as well as task data 1212.

FIG. 12B depicts a system 1220 that includes a client server architecture. One or more user PCs 1222 accesses one or more servers 1224 running a financial close management engine 1226 on a processing system 1227 via one or more networks 1228. The one or more servers 1224 may access a computer readable memory 1230 as well as one or more data stores 1232. The one or more data stores 1232 may contain accounting data 1234 as well as task data 1236.

FIG. 12C shows a block diagram of exemplary hardware for a standalone computer architecture 1250, such as the architecture depicted in FIG. 12A that may be used to contain and/or implement the program instructions of system embodiments of the present invention. A bus 1252 may serve as the information highway interconnecting the other illustrated components of the hardware. A processing system 1254 labeled CPU (central processing unit) (e.g., one or more computer processors), may perform calculations and logic operations required to execute a program. A processor-readable storage medium, such as read only memory (ROM) 1256 and random access memory (RAM) 1258, may be in communication with the processing system 1254 and may contain one or more programming instructions for performing the method of implementing a financial close management engine. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 1260 interfaces one or more optional disk drives to the system bus 1252. These disk drives may be external or internal floppy disk drives such as 1262, external or internal CD-ROM, CD-R, CD-RW or DVD drives such as 1264, or external or internal hard drives 1266. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1260, the ROM 1256 and/or the RAM 1258. Preferably, the processor 1254 may access each component as required.

A display interface 1268 may permit information from the bus 1252 to be displayed on a display 1270 in audio, graphic, or alphanumeric format. Communication with external devices may optionally occur using various communication ports 1272.

In addition to the standard computer-type components, the hardware may also include data input devices, such as a keyboard 1273, or other input device 1274, such as a microphone, remote control, pointer, mouse and/or joystick.

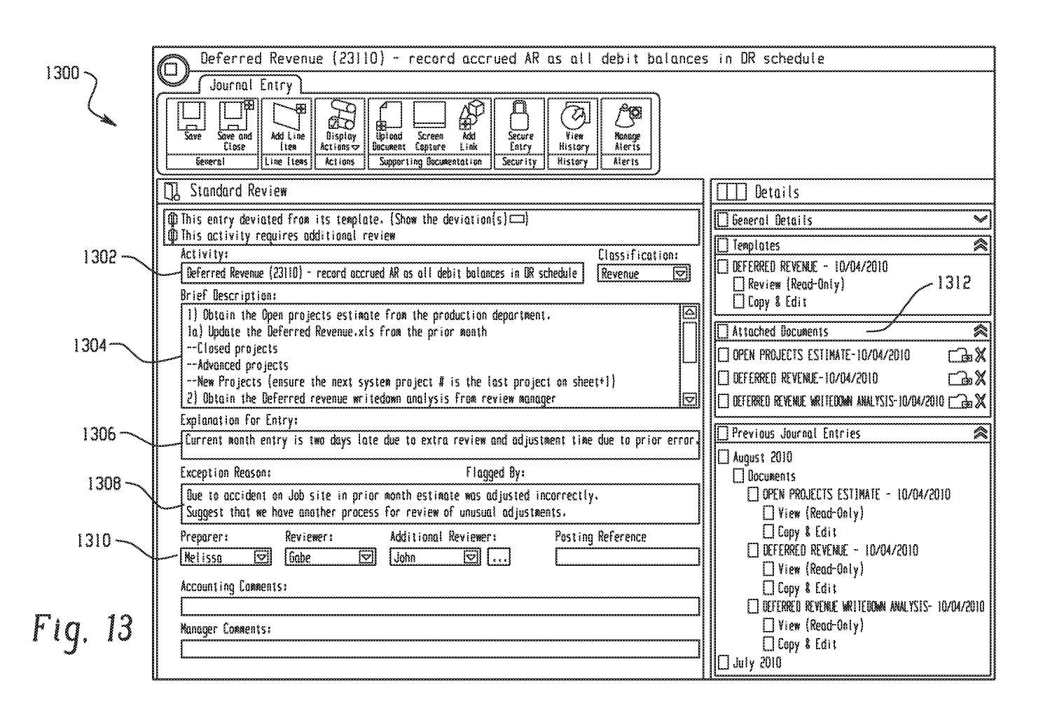

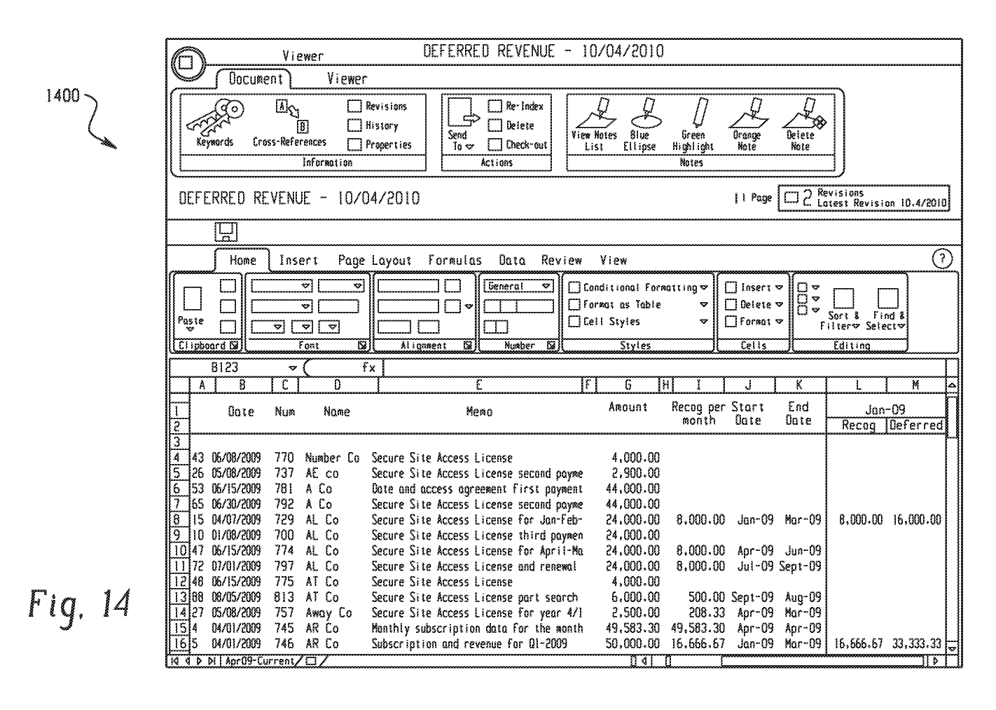

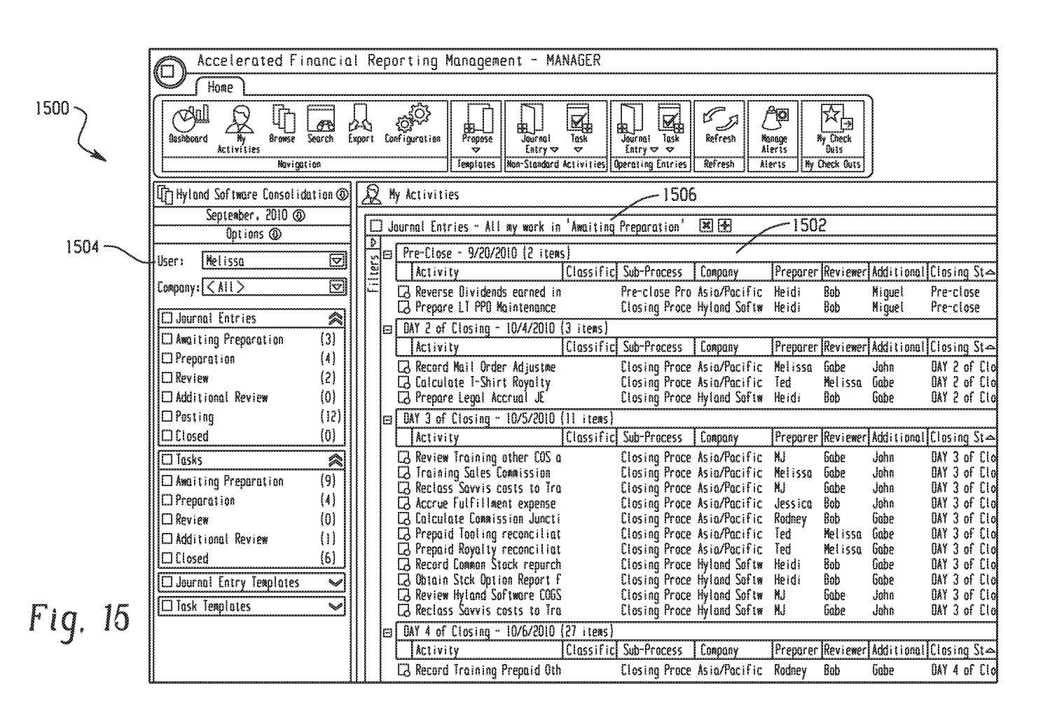

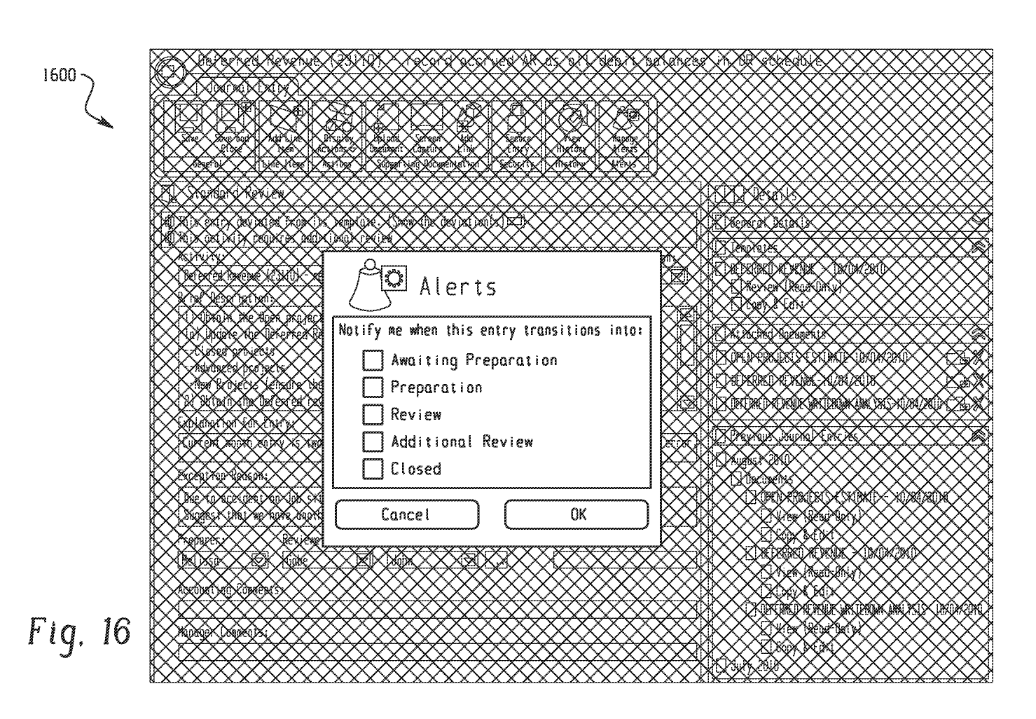

As further examples, FIGS. 13-19 depict example user interfaces for implementing a financial close management engine. FIG. 13 depicts an example task view graphical user interface. The task view screen includes a title of the task activity 1302, the detailed procedures for the task activity 1304, an explanation note for the task activity 1306, an exception reason for the task activity 1308, a notation of users assigned to the task, and links to supporting documentation for the task 1312. FIG. 14 depicts a graphical user interface illustrating one of the supporting documents selected using the graphical user interface of FIG. 13 at 1312. FIG. 15 depicts a graphical user interface containing a task list for a user. The task list 1502 includes a number of tasks associated with Melissa, as indicated at 1504, when those tasks should be completed, and their current status 1506. A task may be selected and worked on, where following completion, the status of the task is updated. FIG. 16 depicts a graphical user interface for setting up alert notifications for a particular task.

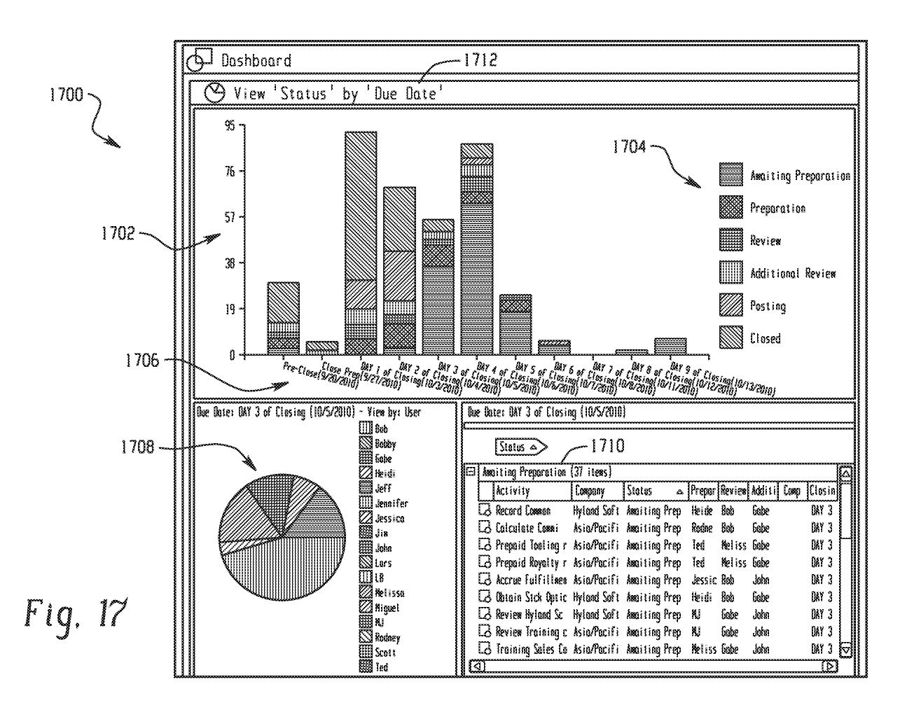

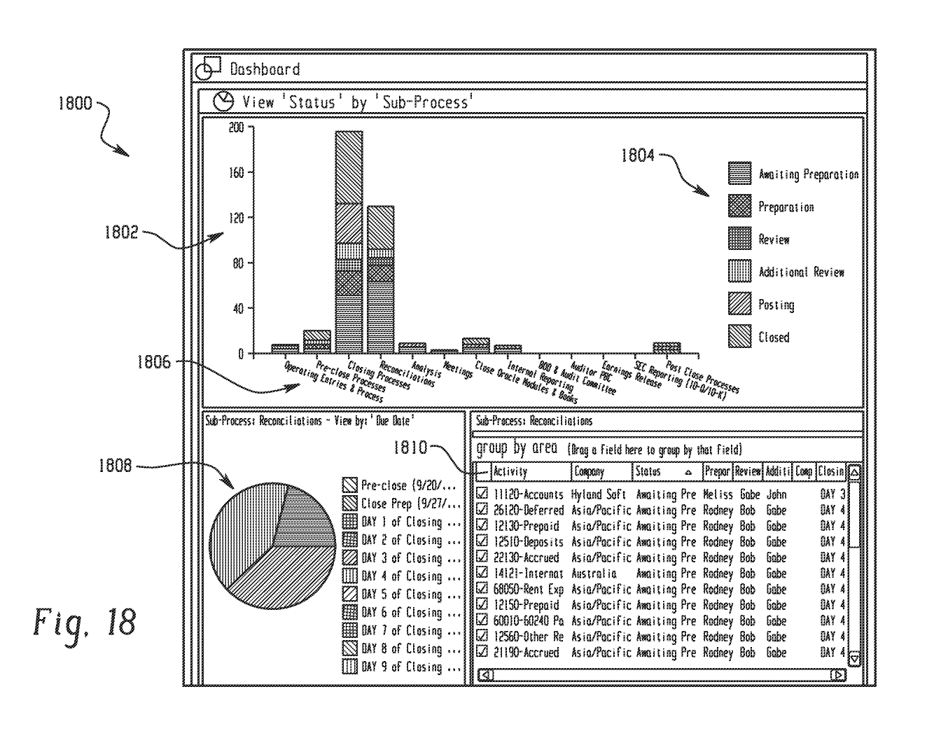

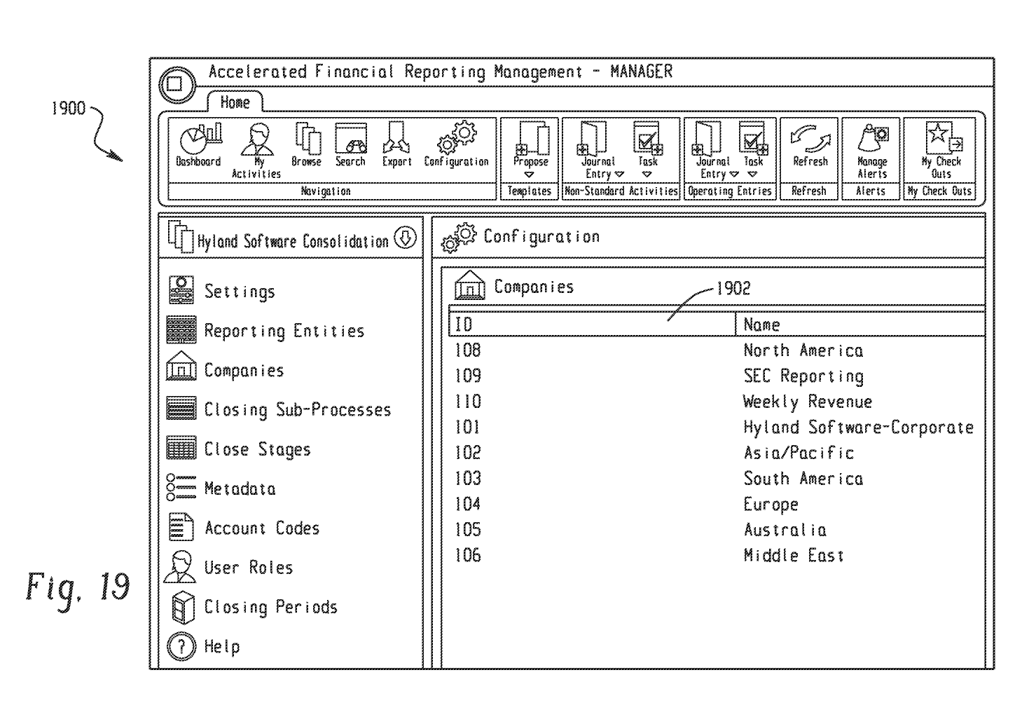

FIG. 17 depicts a graphical user interface showing a financial close status dashboard. The example dashboard shows the number of tasks 1702 having different statuses 1704 at different stages 1706 of the financial close process. The dashboard 1700 includes a second graph 1708 showing tasks having a particular due data according to user, and a listing of all tasks due on a particular due date 1710. The different variables displayed in the graphs can be changed using drop down controls, as exemplified at 1712. Using those controls 1712, a user may access a dashboard as shown in FIG. 18. FIG. 18 depicts another financial close status dashboard showing the number of tasks 1802 having different statuses 1804 according to sub-process 1806. The dashboard 1800 includes a second graph 1808 showing reconciliation tasks and those tasks' associated due dates, and a listing of all reconciliation tasks yet to be completed at 1810. FIG. 19 is a graphical user interface illustrating different entities 1902 related to a company. The depicted entities may share interdependencies that must be resolved in performing financial close processes. By selecting one of the different entities 1902, a user may drill down into the financial close details for that entity. The user may check the status of the financial close for that entity to view any bottlenecks that are slowing the financial close process for other entities listed at 1902.

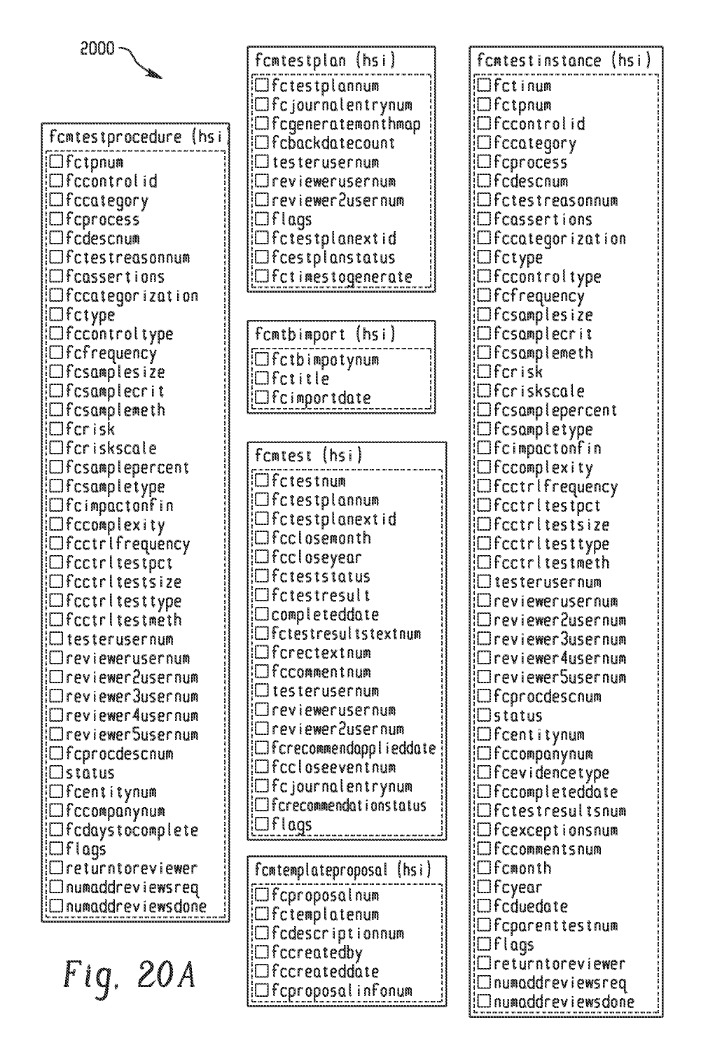

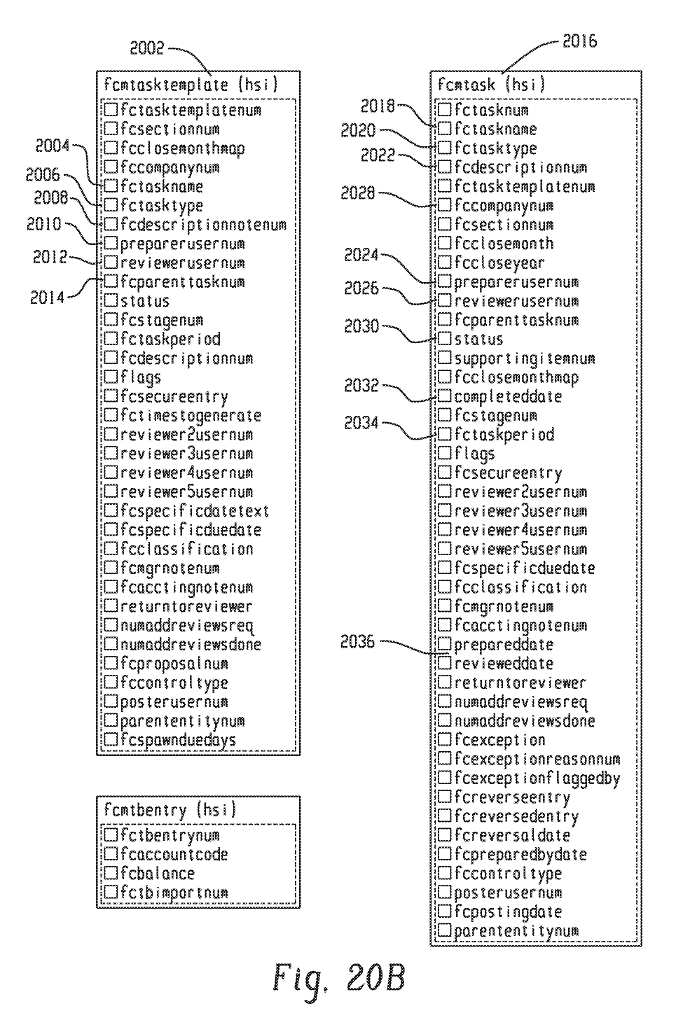

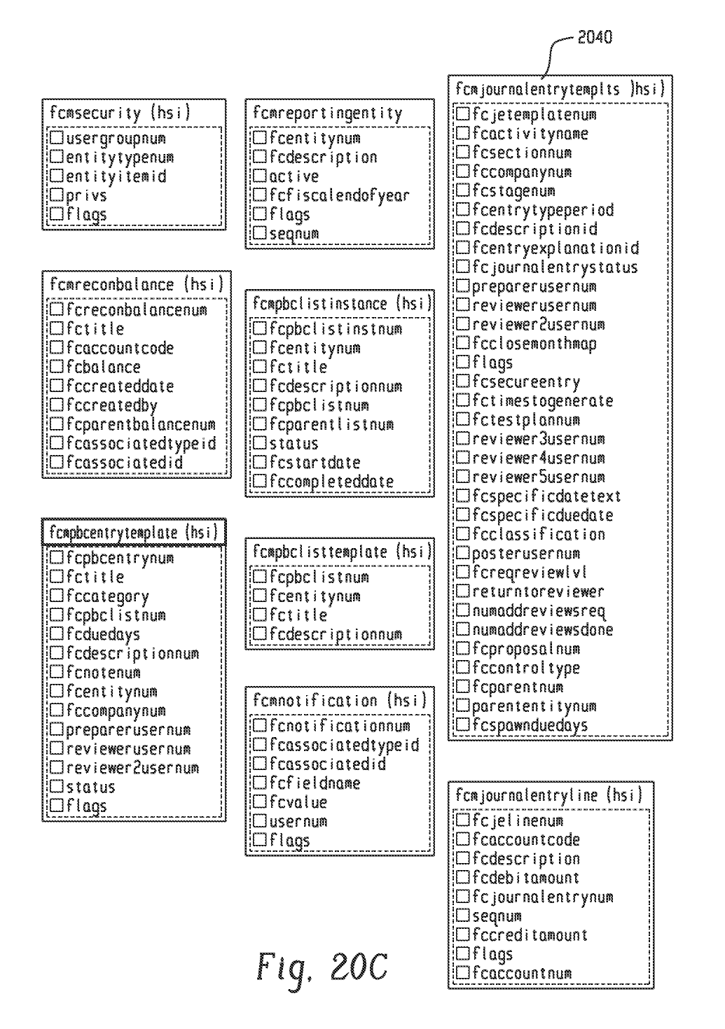

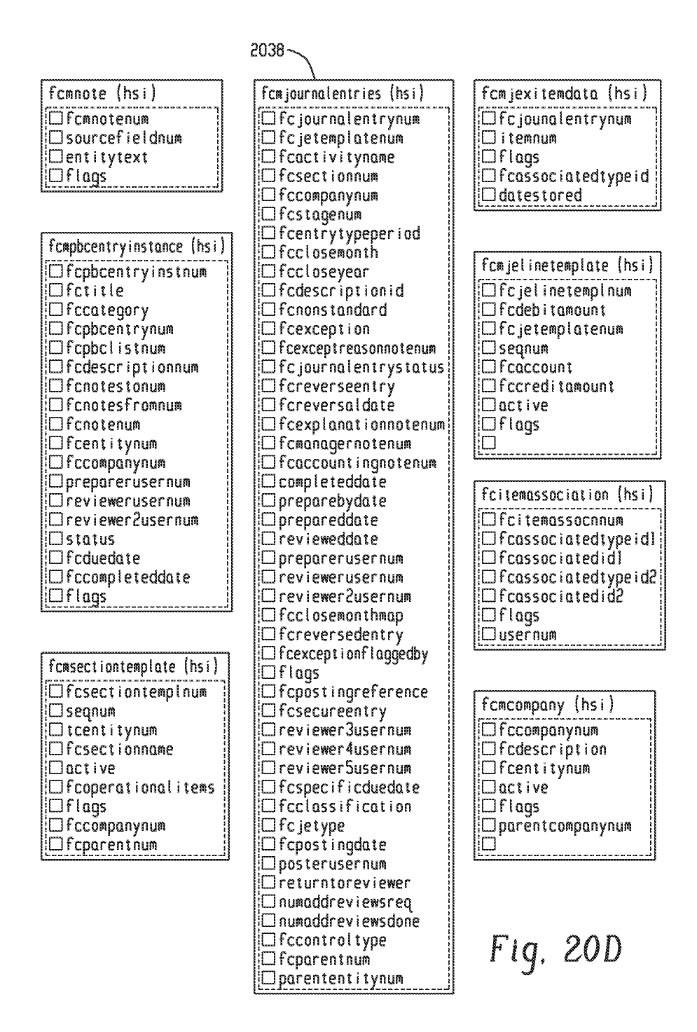

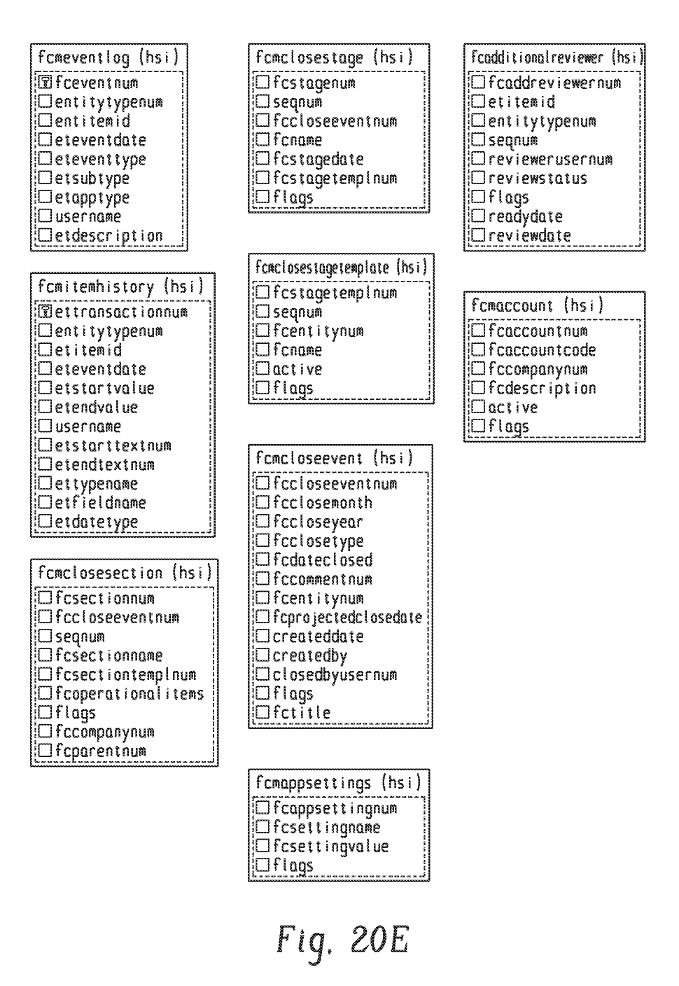

FIGS. 20A, 20B, 20C, 20D, and 20E depict an example task data schema. The task data schema includes a task template table 2002 that includes a task name 2004, a task type 2006, and a link to a task description 2008. The task template includes an identification of a default preparer 2010, default reviewer 2012, as well as identification of a parent task 2014. A task template, as stored in the task template table 2002 may be used to generate data records in the task table 2016. For a task record created using a task template, certain of the fields in the task data record are populated using data from the task template. These fields include the task name 2018, the task type 2020, the link to the task description 2022, the preparer 2024, and the reviewer 2026. The task record identifies the entity with which the task is associated at 2028, a status at 2030, a completion date at 2032, a time period with which the task is associated at 2034, and the dates of preparing and reviewing at 2036.

The data schema 2000 also includes certain accounting data. For example, journal entries can be stored as records in a journal entry table 2038, where journal entry records are initially populated using default data from a journal entry template 2040.

As additional examples, for example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A system for the management automation of the financial reporting process comprising of:
a database stored on a non-transitory computer-readable storage medium that is used to track each of the steps required to perform the financial close for an organization where steps are either general account tasks required to be complete the financial close, accounting tasks that constitute accounting controls or accounting tasks that represent the creation of a journal entry;
a computer user interface that provides each user with visibility to the steps they are required to perform as part of the financial close and allows them to record when they have completed a task, and the ability to see the status of other steps that may be relevant to their ability to perform their task; and
a computer program that allows the financial department management to monitor the progress of each of the steps associated with the close process and to reassign steps to other users.

2. The system in claim 1 that for each task, tracks the user, date and time that a task is prepared, approved and completed.

3. The system in claim 2 that allows a journal entry task to be marked as an exception or unusual entry and providing the capability to create a report of those items.

4. The system in claim 2 that allows a manager to compare the current state of the close on a particular date to the state of the close on the same day on a previous month.

5. The system in claim 1 that allows for the creation of an organizational structure consisting of one-to-many reporting entities each of which has one-to-many companies each of which has many accounting tasks.

6. The system in claim 1 that allows the user preparing a journal entry to attach documents and spreadsheets in performing the accounting task to the task to allow the reviewer to see the work papers or supporting documentation.

7. The system in claim 1 that allows an organization to create one or more task templates each of which will be used to create and pre-populate a monthly task.

8. The system in claim 7 that allows an organization to define the default preparer and approver for a task template.

9. The system in claim 8 that allows an organization to document the accounting procedure in a task template which will then be copied to the monthly task which will allow the user which receives a reassigned task to know the correct procedure to complete the task

10. The system in claim 7 that allows the user preparing a journal entry to attach documents and spreadsheets in performing the accounting task to the task to allow the reviewer to see the work papers or supporting documentation

11. A system in claim 10 that can export the work products to create a provided by client (PBC) as requested by the company's auditors.

12. The system in claim 10 where the task template can be configure to copy the most recent version of the documents attached to the previous month accounting task and copy them over into the current months accounting task to provide the user with a starting point for calculations to be performed for the current month.

13. The system in claim 1 that allows any user to request to be notified when a task is complete.

14. The system in claim 1 that allows any task to contain one-to-many tasks.

15. The system in claim 7 that allows a task template to contain the list of one-to-many users that need to be notified when a task is complete.

16. The system in claim 15 that copies the list of users to be notified from the task template to the monthly task and notified the user when the task is complete.

17. The system in claim 7 that allows any task template to contain one-to-many tasks templates.

18. The system in claim 7 that allows any task template to contain one-to-many tasks templates.

19. The system in claim 9 that allows an organization to manage the review process for the accounting procedures by tracking the time the procedure was last reviewed, and allowing each procedure to be routed to a procedure reviewer and for those that need modification, route procedure to a new procedure writer then a new procedure approver and when the procedure is approved, publish the new procedure to the task template.

20. The system in claim 19 that can be configured with a set of internal audit template tasks that represent the accounting controls over specific accounts. The template tasks have default auditor, reviewer, manager and how frequently these controls must be tested.

21. The system in claim 20 that creates internal audit tasks on the prescribed interval that get assigned to the default auditor and tracks when the audit step was perform, by who, the result and the explanation for any variances or unexpected deviations.

22. The system in claim 21 that identifies to the auditor that an internal audit task is the accounting control over specific accounts whose procedures have been changed since the last time that this internal audit task was performed.

23. The system in claim 21 that provides a dashboard or reports that allow management to track the status of the internal audit process.

24. The system in claim 19 where the user preparing an accounting task that has had its procedure changed sees a visual indication that this is the first month the procedure has been copied to the accounting task for the first time and the user is required to read the new procedure.

25. The system in claim 1 where for accounting task that represent the preparation of a journal entry, the system has a location to store one-to-many journal entries for one-to-many general ledger accounts.

26. The system in claim 21 that allows a preparer or approver to see the previous month journal entries for this task in order to quickly double check to the current month journal entries for both size and direction.

27. The system in claim 21 where the system has a template task that allows the expected accounts and the direction of the entries which will be copy to the monthly accounting task.

28. The system in claim 23 where the system has a template task that can be configured with acceptable range values for the amount of the entry on the account and will generate notifications when an amount is out of the expected range.

29. The system in claim 21 where the system will compute historical acceptable value ranges and will provide a notification when an amount is outside the typical range for that account.

30. The system in claim 1 that allows a preparer or approver to see the previous months accounting task in order to quickly double check when the current month results are expected to be similar to the previous month results.

31. One or more computer-readable storage mediums for storing data structures for access by an application program being executed on one or more data processors for managing a financial close process, comprising:
a plurality of data structures including:
a task template table for storing task template data records that identify default values for a plurality of fields of a task data record including:
a task name;
a task description;
a task preparer; and
a task reviewer;
a task table for storing task data records having default values for the plurality of fields according to a task template data records, wherein a task name, a task description, a task preparer, and a task reviewer are pre-populated for a particular task data record based on a particular task template data record associated with the particular task record.
